(19) United States
(12) Patent Application Publication
(10) Pub. No.: US 2012/0166347 A1
(43) Pub. Date: Jun. 28, 2012

(54) GEOSPATIAL INCONSISTENCIES IDENTIFICATION DATA SYSTEM BASED ON CONTRACTUAL RIGHTS AND GEOGRAPHICAL NETWORK ANALYSIS

(75) Inventor: JOSE LACAL, BOYNTON BEACH, FL (US)

(73) Assignee: DATASTREAM CONTENT SOLUTIONS, LLC, COLLEGE PARK, MD (US)

(21) Appl. No.: 12/979,743

(22) Filed: Dec. 28, 2010

(51) Int. Cl. G06Q 99/00

(52) U.S. Cl. 705/317

(57) ABSTRACT

An application document for a contractual right can be identified. The application document can be a new application seeking a contractural right or an existing one for which a contractual right has already been granted yet which is being verified herein. The contractual right can define a compensatory relationship between two entities for specified conditions. At least one address can be determined from the application document, where activities related to the contractual right are to be performed. The address can be converted into geospatial coordinates. A database of geospatially recorded items can be queried for activities proximate to the geospatial coordinates. A geospatial inconsistency score can be generated based on the results from the database and their level of incompatibility with conducting the activity for which the contractual right is related.

### BACKGROUND

The present invention relates to the field of data systems and, more particularly, to a geospatial inconsistencies identification data system based on contractual rights and geographical network analysis.

Backlogs and the sheer volume of applications have rendered current procedures for identifying the misrepresentation or misappropriation of contractual rights (e.g., licenses, permits, grants, policies, entitlement to benefits, etc.) ineffective. Issuing agencies and organizations for contractual rights exist for a variety of services (e.g., health/life/fire/auto/property insurances, benefit disbursements) and at varying levels of government (e.g., federal, state, and local) as well as within the private and non-profit sectors. Each agency/organization maintains a collection of application data submitted for contractual rights consideration.

Many of the data items collected from a contractual rights application for one type of right or by one type of agency/organization often coincide with or are similar to data items collected for a different type of right or by another agency/organization. For example, items of identifying information (e.g., name, address, date of birth, etc.) collected by an insurance company for a policyholder often overlap with items collected by government agencies (i.e., a state-level Bureau of Labor or Workmans Compensation Agency).

This physical and/or political dissociation in data has created an environment where it is difficult to assess fraudulent intentions for submitted and for existing contractual rights applications. While most private and public agencies/organizations have procedures in place for identifying such fraudulent activities, determinations by these procedures are often belated, decreasing the recoupment of improperly made payments. In many instances only post-approval safeguards are in place, which permits fraudulent activity to be performed until an agent physically investigates a right grantee and discovers deception.

For example, licenses to provide government-subsidized healthcare services (e.g., MEDICARE and MEDICAID) are issued to an individual or organization at a specified location or address, often without prior assessment of the appropriateness of the service in relation to the address. Fraudulent claims are then submitted and payment received. By the time the individual or organization is audited or assessed, the fraudulent operation at the address has already been suspended, if there was ever an actual entity at the location.

Conventional contractual rights approval and renewal processes, and often the related computing systems, focus only on the validity (i.e., capable of receiving postal deliveries) of a mailing address provided by the requestor in the application. Many valid mailing addresses exist in areas unsuitable or unable to support the business and/or other activities associated with certain contractual rights.

For example, a cemetery has a valid mailing address. However, a cemetery is not a suitable place to be used as a mailing address when requesting or renewing a contractual right like a healthcare provider license or daycare provider license.

### BRIEF SUMMARY

The disclosure can be performed in accordance with numerous aspects and embodiments detailed herein. One aspect can include a method, a computer program product, a system, and a device for detecting geospatial inconsistencies for requested and/or existing contractual rights. In the aspect, an application document for a contractual right can be identified. The contractual right can define a compensatory relationship between two entities for specified conditions. At least one address can be determined from the application document, renewal application, or list of current grantees, where activities related to the contractual right are to be performed or are currently being performed. The address can be converted into geospatial coordinates. A database of geospatially recorded items can be queried for activities proximate to the geospatial coordinates. A geospatial inconsistency score can be generated based on the results from the database and their level of incompatibility with conducting the activity for which the contractual right is sought or is currently granted. When the geospatial inconsistency score is less than or equal to a previously established threshold, an indication can be provided that no problem has been detected that indicates that the contractual right should not be granted, renewed or continued. When the geospatial inconsistency score exceeds a previously established threshold, an indication can be provided indicating that a problem has been detected that indicates that further analysis should be conducted before the contractual right is granted, renewed, or continued.

One aspect can include a method, a computer program product, a system, and a device for identifying inconsistencies contained in contractual rights requests, renewals, or continuations. The aspect can include contractual rights data, at least one message for a contractual right, and a contractual rights inconsistencies identification data system. The contractual rights data can be obtained from a plurality data sources, such as different privately and/or publicly available data sources (e.g., flat files, databases, etc.). These data sources can be combined and information within them can be stored with geospatial identifiers, such as latitude and longitude values. Each request for a contractual right can be submitted by an entity, wherein said message comprises a plurality of data provided by the entity. The message can include an address for conducting the activity for which the contractual right is sought or has been granted. A plurality of inconsistency rulesets can exist, each defining conditions indicative of misrepresentation and/or probability of fraudulent intent by the submitting entity. The rulesets can be customized for different contexts (i.e., healthcare fraud, disability/income assistance fraud, insurance fraud, etc.). Conditions of the rulesets can be expressed in terms of the data contained in the contractual rights request. The contractual rights inconsistencies identification data system can be configured to generate an inconsistency report for the contractual rights request. The inconsistency report can expresses a likelihood of misrepresentation and/or probability of fraudulent intent by the entity based upon the data of the contractual rights request, the plurality of inconsistency rulesets, and a geocoded contractual rights data warehouse. The geocoded contractual rights data warehouse can be synthesized from the plurality of data sources.

Another aspect of the disclosure can include a method, a computer program product, a system, and a device for identifying inconsistencies contained in contractual rights requests, renewals, or continuations. In this aspect, a data warehouse of contractual rights can be synthesized from a plurality of data sources by a contractual rights inconsistencies identification data system. Each record of the data warehouse can have at least one address of a physical location that contains geospatial information for an address. In response to receipt of a new request for a contractual right, the contents of the new request can be analyzed with respect to the data warehouse. A geospatial inconsistency score can be calculated for the new request using the results of the analysis. The geospatial inconsistency score can represent the likelihood of the new request to be used for fraudulent activities. The calculated geospatial inconsistency score can be compared with a predetermined inconsistency threshold value. An inconsistency report can be generated for the new request comprising results of the new request analysis and/or the geospatial inconsistency score comparison. The inconsistency report can be conveyed to a designated human agent.

### BRIEF DESCRIPTION OF THE SEVERAL VIEWS OF THE DRAWINGS

FIG. 1 is a schematic diagram illustrating a system for utilizing a contractual rights inconsistencies identification data system in accordance with embodiments of the inventive arrangements disclosed herein.

FIG. 2 is an illustrated process flow for a contractual rights inconsistencies identification data system in accordance with an embodiment of the inventive arrangements disclosed herein.

FIG. 3 is a flow chart of a method describing the assessment of a contractual rights request by a contractual rights inconsistencies identification data system in accordance with an embodiment of the inventive arrangements disclosed herein.

FIG. 4 is a flow chart of a method describing the creation of the geocoded contractual rights data warehouse by a contractual rights inconsistencies identification data system in accordance with an embodiment of the inventive arrangements disclosed herein.

FIG. 5 is a diagram of an example database schema that can be used for a geocoded contractual rights data warehouse in accordance with embodiments of the inventive arrangements disclosed herein.

FIG. 6 is an illustration of an example inconsistencies identification user interface in accordance with embodiments of the inventive arrangements disclosed herein.

FIG. 7 is a diagram illustrating the contextual data realized for mailing addresses by the contractual rights inconsistencies identification system in accordance with embodiments of the inventive arrangements disclosed herein.

### DETAILED DESCRIPTION

The present invention discloses a solution for identifying inconsistencies contained in contractual rights applications indicating potential fraudulent submissions prior to approval, renewal, or continuation of the contractual rights applications. A contractual rights inconsistencies identification data system can be used to generate a geocoded contractual rights data warehouse from a variety of disparate data sources. In one embodiment these disparate data sources can consist entirely of open source information repositories. These open source repositories can indicate a likelihood of incompatible purposes for a set of stated addresses. For example, if a mailing address is within the defined geographical boundaries of a cemetery, it would not be possible (or at least highly unlikely) that a valid healthcare-related business is being conducted from that address. Historical address checks have yielded only whether an address was a valid postal address and have not compared the context or purpose of that address with other records. With the present invention, the mailing addresses provided within an application for a contractual right can be geocoded (given a geospatial designator), which is compared to a repository of geospatially-related information to determine a compatibility or incompatibility of the submitted mailing address for the purpose of the requested contractual right. Further investigations can be taken, when an incompatibility is likely and before (or after) the contractual right is granted.

In other words, records of the geocoded contractual rights data warehouse can include geospatial information for physical addresses associated with locations contained in the source data. Based upon the geocoded contractual rights data warehouse and inconsistency rulesets, the contractual rights inconsistencies identification data system can calculate a geospatial inconsistency score for new contractual rights applications. The rulesets can include general ones for permission to conduct any type of business or enterprise. The rulesets can also include specific ones for specific purposes. Rulesets can be enhanced over time and can be weighted, to improve results of the system over time. The geospatial inconsistency score generated via application of the rulesets to situation specific parameters can be used as an indicator as to the probability of fraudulent activities occurring in connection with the contractual rights application.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

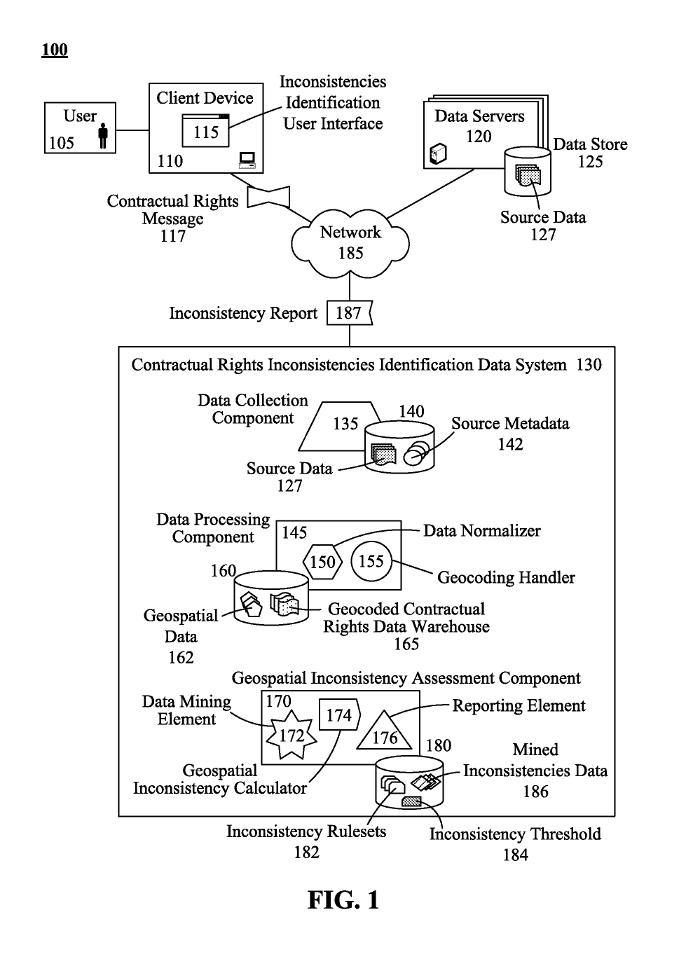

FIG. 1 is a schematic diagram illustrating a system 100 for utilizing a contractual rights inconsistencies identification data system 130 in accordance with embodiments of the inventive arrangements disclosed herein. In system 100, a user 105 can utilize the contractual rights inconsistencies identification data system 130, herein referred to as the inconsistencies system, to produce an inconsistency report 187 for a contractual rights message 117, where the message 117 can be a request for a new contractual right, a renewal, or a continuation.

As used herein, a contractual right can refer to an obligatory agreement between entities in which the contracted entity grants a compensatory benefit to the contracting entity when specified conditions are met. A prime example of a contractual right, and one discussed in subsequent Figures, can be a government right like a license, a grant, a permit, an accreditation, or any other non-inherent right conferred by a government entity (state, federal, or local) upon an individual or business. For example, the Department of Housing and Urban Development (HUD) can provide a variety of grants for building projects to be performed in communities of specific ethnic compositions. Such a grant can represent the federal government's agreement to provide a builder with compensation (e.g., monies, tax breaks) for undertaking and completing a building project.

In some instances, non-governmental entities can be afforded a power to selectively impart a right to an individual or company in lieu of the governmental entity. In such cases, the rights granted by these (strictly speaking) non-governmental entities are to be considered government rights, and, therefore, contractual rights, for purposes disclosed herein. For example, medical boards, law regulation bars, universities, regulatory bodies, home-owner associations, and the like can grant “government rights” as utilized herein.

Insurance policies can represent another type of a contractual right. The insurance company can provide an individual or organization with various forms of compensation for submitted claims. For example, a submitted claim can represent the contractee's testimony that the specified conditions of the contractual right have been fulfilled, so as to receive compensation from the insurance company.

The inconsistencies system 130 can be accessed by the user 105 using the inconsistencies identification user interface 115 running on a client device 110. The client device 110 can represent a variety of computing devices capable of supporting performance of the inconsistencies identification user interface 115 and communicating with the inconsistencies system 130 over a network 185.

Via the inconsistencies identification user interface 115, the user 105 can enter data for or select a previously-stored contractual rights message 117 for processing by the inconsistencies system 130. For example, a user 105 can upload a file containing the records into the inconsistencies system 130 that are to be processed and have inconsistencies reports 187 generated.

The contractual rights message 117 can correspond to an electronic representation of the data currently collected during the application process for the specified contractual right. In one embodiment, additional fields and/or questions can be included in existing contractual rights message 117 to provide data elements valuable for system 100.

In one embodiment, the inconsistencies system 130 can be operated by a third-party entity contracted by various contractual rights agencies/organizations. As such, the third-party entity can obtain the data representing the contractual rights message 117 from the issuing agency/organization. In such an embodiment, the data for the contractual rights message 117 can be stored in a data store of the inconsistencies system 130 for subsequent processing.

In another embodiment, the inconsistencies system 130 can operate internal to the issuing agency/organization (i.e., a data system running on an enterprise network). With such an embodiment, the inconsistencies system 130 can be configured to communicate with a secondary data system (not shown) to obtain the contractual rights message 117 data.

In one embodiment, personal information included in a contractual rights message 117 can be protected to ensure privacy, confidential, and personal information is not compromised. For example, in one configuration the inconsistent identification data system 130 can intentionally discard personal information (contained in the contractual rights message 117) after running a suitable inconsistency report 187. In another embodiment, however, specific contractual rights message 117 data can be recorded by the inconsistencies system 130 to determine patterns consistent with proper application and improper ones. That is, pattern-based analysis tools can be developed and incorporated within the inconsistencies system 130 to improve performance via feedback over time.

The pattern-based analysis tool would provide an automated means by which a large volume of data can be processed to identify behavioral trends and/or fluctuations. In such an embodiment, the results of these assessments can be utilized by the internal components of the inconsistencies system 130.

In one configuration a balanced approach can be taken, where all personal information is protected by the inconsistencies system 130, but, where information that is publically available within the contractual rights message 117 can be retained by the inconsistencies system 130.

The inconsistencies system 130 can represent the hardware and/or software components required to support functions for identifying inconsistencies within contractual rights requests 117 data that can indicate fraudulent activities and/or claims. That is, inconsistencies system 130 can utilize one or more machines that include a processor, volatile memory, nonvolatile memory, semiconductor products (e.g., a motherboard and related cards/components), a network adaptor card, input/output hardware, and a bus connecting the components. Software and/or firmware (which can be called computer program products) can be stored on the volatile and non-volatile memory of the inconsistencies system 130 and can include a set of computer readable instructions, which are executable on the processor. System 130 can optionally utilize distributed computing principles, virtualization techniques, failover capabilities, and/or other known computer science implementation choices. Further, the inconsistencies system 130 can include a data collection component 135, a data processing component 145, and a geospatial inconsistency assessment component 170.

The data collection component 135 can be configured to gather source data 127 from the data stores 125 of designated data servers 120. The data servers 120 can belong to a variety of entities having source data 127 pertaining to contractual rights and/or related information. These entities can represent private organizations (i.e., non-profit groups, insurance companies, etc.) as well as public organizations (i.e., government agencies).

Examples of public organizations that can provide source data 127 can include, but are not limited to, the Dept. of Housing and Urban Development (HUD), the Dept. of Health and Human Services (HHS), the Federal Communications Commission (FCC), the Federal Aviation Authority (FAA), the Dept. of Education, the Dept. of Commerce, state-level licensing agencies, social media networks, and the like.

It should be noted that, although the above examples reflect the organizational structure of the United States government, this embodiment of the present invention is not limited to such a structure. That is, inconsistencies system 130 can be configured for use with various governmental or authoritative structures.

Depending upon the data server 120, the data collection component 135 can be configured to provide authentication to access the source data 127. For example, the data collection component 135 can utilize a public key infrastructure (PKI) certificate for authentication to a database 125 containing medical licensing data 127 from a known data server 120 of the State Medical Board.

Collection of the source data 127 can involve multiple techniques such as scheduled file downloads, data feeds or really simple syndication (RSS) feeds, Web site crawling, and the like. Accessing the source data 127 can also require additional usage agreements between the operator of the inconsistencies system 130 and the controlling entity of the data server 120, especially when the controlling entity is a private organization and/or the source data 127 is not publicly available.

The data collection component 135 can be further configured to handle acquisition of the contractual rights message 117 data, automatically or via user 105 request. The collected source data 127 can be stored in a data store 140 accessible to the data collection component 135.

Additionally, the data collection component 135 can extract and store source metadata 142 regarding the data server 120 and/or source data 127, such as the universal resource locator (URL) from which the source data 127 was retrieved. The source metadata 142 can be used to describe the format and/or data structure of the source data 127 to ensure data integrity when subsequently accessed by the data processing component 145.

The data processing component 145 can be the component of the inconsistencies system 130 configured to synthesize the collected source data 127 into a geocoded contractual rights data warehouse 165. The data processing component 145 can include a data normalizer 150, a geocoding handler 155, and a data store 160 containing geospatial data 162.

As typical in data processing systems, the data normalizer 150 can be used to normalize data fields of the source data 127 that can be stored in different formats by different data servers 120. For example, the data normalizer 150 can convert phone numbers of any format (i.e., 555-555-5555, (555) 555-5555, 555-5555) to a predetermined format of 555-555-5555.

The geocoding handler 155 can then determine geospatial information for any physical addresses included in the source data 127 normalized by the data normalizer 150. To do so, the geocoding handler 155 can utilize geospatial data 162 contained in an accessible data store 160. The geospatial information determined by the geocoding handler 155 can include the longitude and latitude values for the address as well as a geohash value.

In an alternate embodiment, the geospatial data 162 can be obtained and/or maintained by a third-party entity accessible by the inconsistencies system 130 via network 185.

Once the geocoding handler 155 is finished, the processed source data 127 can be stored as records within the geocoded contractual rights data warehouse 165. The data processing component 145 can be further configured to include additional data handling tools and/or algorithms that can be used upon the geocoded contractual rights data warehouse 165.

For example, the data processing component 145 can include data analysis tools/algorithms configured to perform quality assurance operations upon the geocoded contractual rights data warehouse 165 similar to identifying data trends or logical inconsistencies.

The geocoded contractual rights data warehouse 165 can be used by the geospatial inconsistency assessment component 170 to create the inconsistency report 187 for the contractual rights message 117 being analyzed. The geospatial inconsistency assessment component 170 can include a data mining element 172, a geospatial inconsistency calculator 174, and a reporting element 176.

The data mining element 172 can be configured to generate mined inconsistencies data 186 from the geocoded contractual rights data warehouse 165 for the contractual rights message 117. The data mining element 172 can utilize additional software tools similar to the WEKA DATA MINING TOOLKIT.

In another embodiment, the data mining element 172 can be configured to generate mined inconsistencies data 186 for the geocoded contractual rights data warehouse 165 as a whole and not in respect to a contractual rights message 117. As such the data mining element 172 can mine and update the mined inconsistencies data 186 at predetermined time intervals or when new data has been added to the geocoded contractual rights data warehouse 165.

The geospatial inconsistency calculator 174 can then determine a geospatial inconsistency score for the contractual rights message 117 based upon the mined inconsistencies data 186 and applicable inconsistencies rulesets 182. The inconsistencies rulesets 182 can comprise rules interpretable by the geospatial inconsistency calculator 174 that represent models of behavior associated with patterns of concern for predicting fraudulent or illegitimate activities.

For example, an inconsistencies ruleset 182 can indicate that establishments applying for liquor licenses should not be located within 100 feet of a licensed daycare or school. As another example, an inconsistencies ruleset 182 can identify individuals or businesses that are conducting business activities without valid contractual rights for the type of business, activities, and/or jurisdictive location.

The inconsistencies rulesets 182 can be logically and functionality categorized to increase the efficiency of the geospatial inconsistency calculator 174. For example, an inconsistencies ruleset 182 containing healthcare-specific rules should only be used when the contractual rights message 117 pertains to healthcare.

Once the inconsistencies rulesets 182 are evaluated, the geospatial inconsistency calculator 174 can determine a value representing the geospatial inconsistency score of the contractual rights message 117. The geospatial inconsistency calculator 174 can utilize various techniques and/or algorithms to calculate the geospatial inconsistency score.

For example, each rule of an inconsistencies ruleset 182 can include an inconsistencies value that can be used in mathematical calculations and/or statistical analyses performed by the geospatial inconsistency calculator 174.

The calculated geospatial inconsistency score can then be compared against a predetermined inconsistency threshold 184. The inconsistency threshold 184 can represent a limit that, when exceeded, indicates a high probability that the contractual rights message 117 has been submitted for fraudulent activities or services. Like the inconsistencies rulesets 182, the inconsistencies system 130 can utilize multiple inconsistency thresholds 184, where each inconsistency threshold 184 can represent the limit for a specific context (e.g., healthcare fraud, insurance fraud, government waste, etc.).

The mined inconsistencies data 186, inconsistencies rulesets 182, and inconsistency threshold 184 can be stored in a data store 180 that is accessible to the geospatial inconsistency assessment component 170.

In another embodiment, data stores 140, 160, and/or 180 can be represented as a single data store containing all the related data 127, 142, 162, 165, 182, 184, and 186.

In yet another embodiment, one or more of the data stores 140, 160, and/or 180 can be located remote to the inconsistencies system 130, accessed via network 185. For example, data stores 140, 160, and/or 180 can correspond to database partitions of a database housed on an enterprise data server.

The reporting element 176 can use the result of the geospatial inconsistency calculator 174 as well as any mined inconsistencies data 186, inconsistencies rulesets 182, and/or records from the geocoded contractual rights data warehouse 165 to generate an inconsistency report 187 for the contractual rights message 117. The inconsistencies system 130 can then provide the generated inconsistency report 187 to the user 105.

It should be emphasized that the analysis performed by the inconsistencies system 130 can be performed prior to the granting of the contractual right and/or disbursement of funds as well as after issuance of the contractual right. The inconsistencies system 130 can aggregate the disparate contractual rights source data 127 into a unified geocoded contractual rights data warehouse 165 that can be assessed and analyzed as a whole.

Network 185 can include any hardware/software/and firmware necessary to convey data encoded within carrier waves. Data can be contained within analog or digital signals and conveyed though data or voice channels. Network 185 can include local components and data pathways necessary for communications to be exchanged among computing device components and between integrated device components and peripheral devices. Network 185 can also include network equipment, such as routers, data lines, hubs, and intermediary servers which together form a data network, such as the Internet. Network 185 can also include circuit-based communication components and mobile communication components, such as telephony switches, modems, cellular communication towers, and the like. Network 185 can include line based and/or wireless communication pathways.

As used herein, presented data stores 125, 140, 160, and 180 can be a physical or virtual storage space configured to store digital information. Data stores 125, 140, 160, and 180 can be physically implemented within any type of hardware including, but not limited to, a magnetic disk, an optical disk, a semiconductor memory, a digitally encoded plastic memory, a holographic memory, or any other recording medium. Data stores 125, 140, 160, and 180 can be a stand-alone storage unit as well as a storage unit formed from a plurality of physical devices. Additionally, information can be stored within data stores 125, 140, 160, and 180 in a variety of manners. For example, information can be stored within a database structure or can be stored within one or more files of a file storage system, where each file may or may not be indexed for information searching purposes. The data stores 125, 140, 160, and 180 can utilize SQL relational database techniques as well as no-SQL database techniques, depending on implementation choices. Further, data stores 125, 140, 160, and/or 180 can utilize one or more encryption mechanisms to protect stored information from unauthorized access.

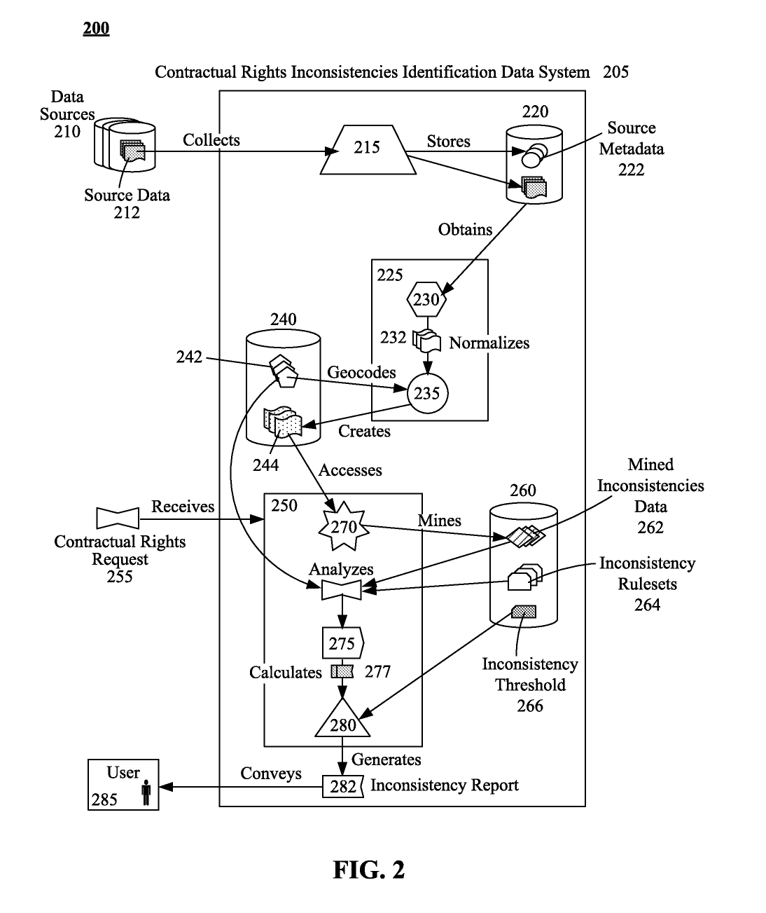

FIG. 2 is an illustrated process flow 200 for a contractual rights inconsistencies identification data system 205 in accordance with embodiments of the inventive arrangements disclosed herein. Process flow 200 can be utilized within the context of system 100.

Process flow 200 can begin the collection of source data 212 from data sources 210 by the data collection component 215 of the contractual rights inconsistencies identification data system 205, herein referred to as the inconsistencies system 205.

The data collection component 215 can then store the source data 212 and source metadata 222 in a data store 220. The data 212 and 222 can then be obtained by the data normalizer 230 of the data processing component 225. The data normalizer 230 can then normalize the source data 212, generating normalized source data 232. For example, the data normalizer 230 can modify the contents of data fields containing address information to conform to the standard abbreviations utilized by the U.S. Post Office.

The normalized source data 232 can be passed to the geocoding handler 235. Using geospatial data 242 contained within data store 240, the geocoding handler 235 can geocode the normalized source data 232, creating the geocoded contractual rights data warehouse 244.

When a contractual rights request 255 is received by the geospatial inconsistency assessment component 250, the data mining element 270 can access the geocoded contractual rights data warehouse 244 and generate mined inconsistencies data 262. The data mining element 270 can store the mined inconsistencies data 262 in a data store 260.

The geospatial inconsistency assessment component 250 can then use the mined inconsistencies data 262, geocoded contractual rights data warehouse 244, and one or more inconsistencies rulesets 264 to analyze the contractual rights request 255. The geospatial inconsistency calculator 275 can use the results of this analysis to calculate a geospatial inconsistency score 277 for the contractual rights request 255.

The reporting element 280 can compare the geospatial inconsistency score 277 to the inconsistency threshold 266 and generate a corresponding inconsistency report 282. The inconsistencies system 205 can then convey the inconsistency report 282 to a requesting or designated user 285.

It should be noted that the user 285 receiving the inconsistency report 282 can be a software application or business process as well as an actual human user. That is, the generated inconsistency report 282 can be provided to other systems and/or services, which can utilize the contents of the inconsistency report 282 as input data for additional processing.

As used herein, presented data stores 210, 220, 240, and 260 can be a physical or virtual storage space configured to store digital information. Data stores 210, 220, 240, and 260 can be physically implemented within any type of hardware including, but not limited to, a magnetic disk, an optical disk, a semiconductor memory, a digitally encoded plastic memory, a holographic memory, or any other recording medium. Data stores 210, 220, 240, and 260 can be a stand-alone storage unit as well as a storage unit formed from a plurality of physical devices. Additionally, information can be stored within data stores 210, 220, 240, and 260 in a variety of manners. For example, information can be stored within a database structure or can be stored within one or more files of a file storage system, where each file may or may not be indexed for information searching purposes. Further, data stores 210, 220, 240, and/or 260 can utilize one or more encryption mechanisms to protect stored information from unauthorized access.

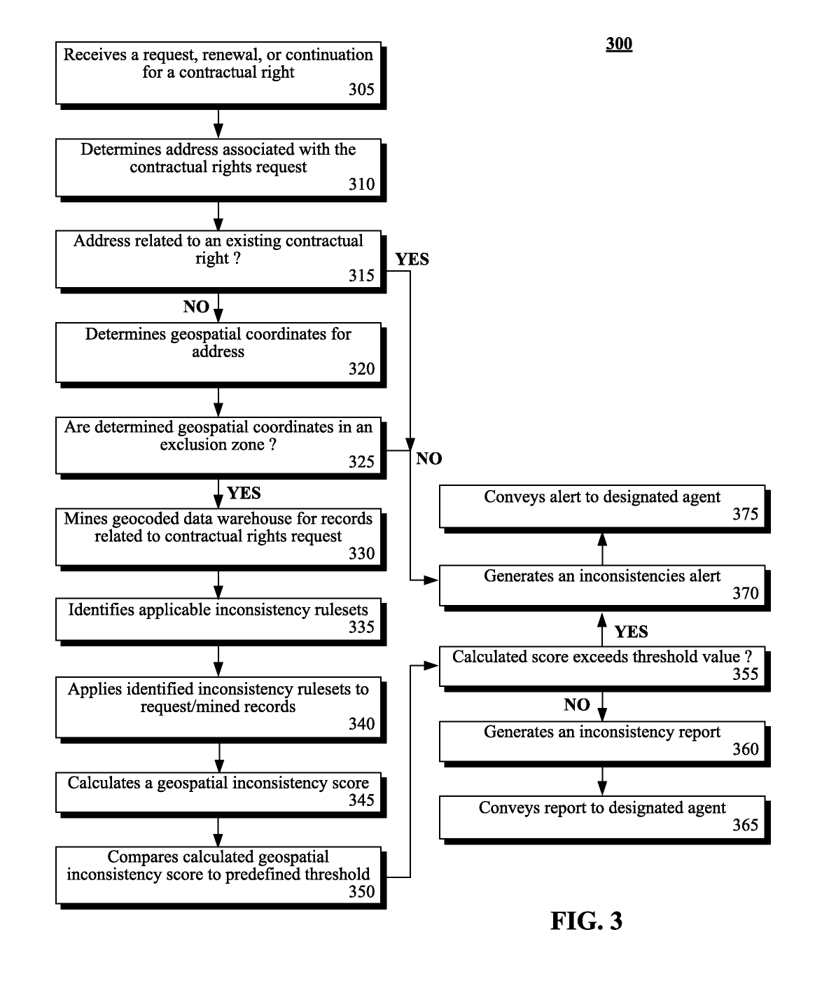

FIG. 3 is a flow chart of a method 300 describing the assessment of a contractual rights request by a contractual rights inconsistencies identification data system in accordance with embodiments of the inventive arrangements disclosed herein. The steps of method 300 can be performed within the context of system 100 and/or in conjunction with process flow 200.

Method 300 can begin in step 305 where the inconsistencies system can receive a request for a contractual right, a renewal, or a continuation. The request, renewal, or continutation for the contractual right can be represented in a variety of ways, dependent upon the type of contractual right being requested, such as a permit application or an insurance claim.

In step 310, one or more addresses associated with the contractual rights request, renewal, or continutation can be determined. It can be determined if the determined address is related to an existing contractual right in step 315.

When the address is not related to an existing contractual right, step 320 can execute where geospatial coordinates can be determined for the address. In step 325, it can be determined if the geospatial coordinates determined in step 320 are in a valid geographic area. For example, the geospatial coordinates for the address should not fall within the geospatial coordinates of public parks, waterways, or undeveloped lands.

To support performance of step 325, the inconsistencies system can maintain a library of geographic exclusion zones as part of the geospatial data. A geographic exclusion zone can represent a geographic location whose use is unsuitable or restrictive for specific types of activities. For example, geospatial coordinates defining non-residential areas (e.g., quarries, landfills, cemeteries, etc.) can be used as geographical exclusion zones for healthcare-related contractual rights requests.

When the geospatial coordinates are determined to be valid, the geocoded contractual rights data warehouse can be mined for records related to the contractual rights request in step 330. In step 335, inconsistency rulesets that apply to the contractual rights request can be identified.

Step 335 can include the querying of metadata or keywords associated with the inconsistency rulesets for data fields or keywords extracted from the contractual rights request. For example, when processing a MEDICAID provider request, the inconsistency rulesets can be queried to find those rulesets that pertain to healthcare, MEDICAID, and/or the affiliation of the requestor.

In step 340, the identified inconsistency rulesets can then be applied to the contractual rights request and/or mined inconsistencies data from step 330. A geospatial inconsistency score can be calculated for the contractual rights request in step 345.

In step 350, the calculated geospatial inconsistency score can be compared to a predefined threshold. It can be determined if the calculated geospatial inconsistency score exceeds the threshold value in step 355.

When the threshold value is not exceeded, an inconsistency report can be generated for the contractual rights request in step 360. In step 365, the generated inconsistency report can be conveyed to a designated agent.

When the threshold value is exceeded by the calculated geospatial inconsistency score or when the address associated with the contractual rights request is related to an existing contractual right or when the geospatial coordinates determined for the address are invalid, flow of method 300 can proceed to step 370 where an inconsistencies alert can be generated. The inconsistencies alert can then be conveyed to a designated agent in step 375.

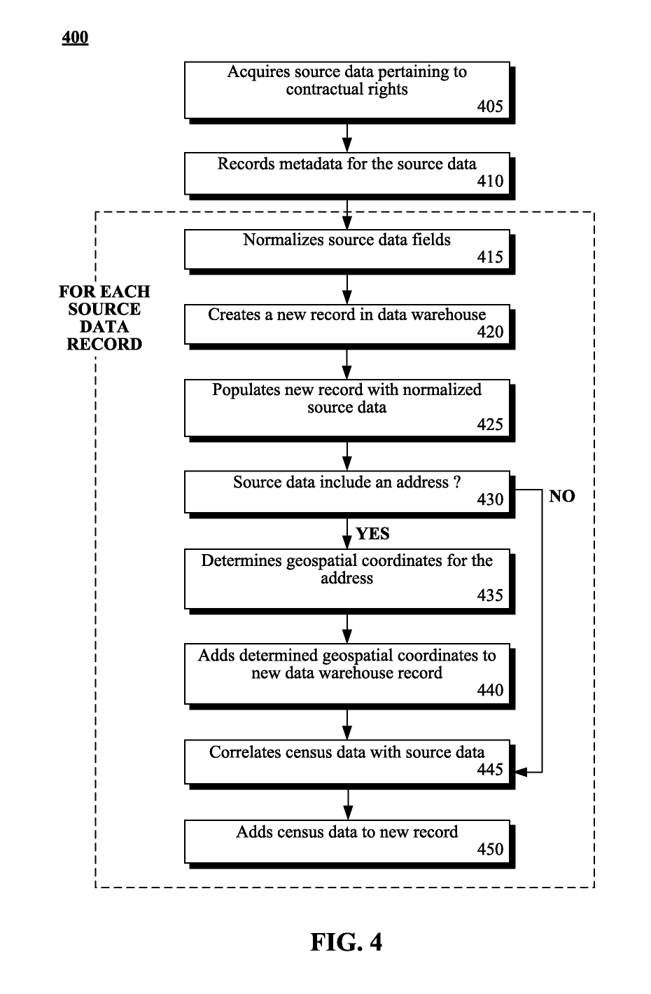

FIG. 4 is a flow chart of a method 400 describing the creation of the geocoded contractual rights data warehouse by a contractual rights inconsistencies identification data system in accordance with embodiments of the inventive arrangements disclosed herein. The steps of method 400 can be performed within the context of system 100 and/or in conjunction with process flow 200.

Method 400 can begin in step 405 where the data collection component of the inconsistencies system can acquire source data pertaining to contractual rights from various private and/or public data sources. Metadata regarding the source data can be recorded in step 410.

The remaining steps of method 400 can be performed for each record contained in the acquired source data. In step 415, the data fields of the source data can be normalized. A new record in the geocoded contractual rights data warehouse can be created in step 420.

In step 425, the new record can be populated with the normalized source data. It can be determined if the source data includes an address in step 430. When the source data includes an address, step 435 can execute where geospatial coordinates can be determined for the address.

The determined geospatial coordinates can then be added to the new geocoded contractual rights data warehouse record in step 440. Upon completion of step 440 or when the source data does not include an address, step 445 can be performed where census data corresponding to the exact location of the address can be correlated to the source data. The correlated census data can be added to the new geocoded contractual rights data warehouse record in step 450.

The census data utilized by steps 445 and/or 450 can refer to characterization data collected from people and/or businesses. For example, a private or public institution can use census data to better understand the geographical areas where its clients or customers live or work.

Additionally, the census data can correspond to the variety of data collected by the U.S. Census Bureau or other applicable government agency. The census data obtained from the U.S. Census Bureau can include cartographic data (e.g., roads, rivers, lakes, etc.) as well as demographic data (e.g., race, income, educational level, etc.) like that collected by the American Community Survey.

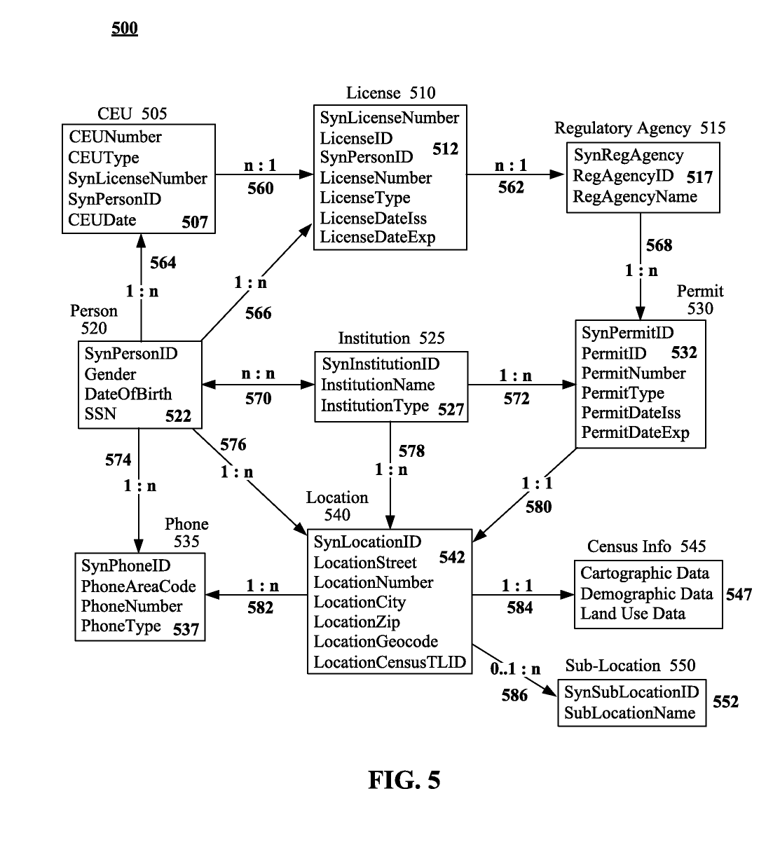

FIG. 5 is a diagram of an example database schema 500 that can be used for a geocoded contractual rights data warehouse in accordance with embodiments of the inventive arrangements disclosed herein. Database schema 500 can be utilized by system 100, process flow 200, method 300 and/or method 400.

Although schema 500 is written in terms of a third normal form relational database, the disclosure is not so limited. In other words, schema 500 is used to express one standard mechanism for storing attributes considered herein. Other schemas (than schema 500) can be utilized for equivalent purposes. Additionally, other forms of database (such as a NOSQL database) can be utilized, which by nature will utilize a schema different from that shown in FIG. 5. All approximately equivalent structures for database are well within the skill of an ordinary implementer and are to be considered within scope of this disclosure.

Database schema 500 can include a variety of data tables 505-550, such as those shown in this example. The database schema 500 can be designed to define a data structure for the geocoded contractual rights data warehouse. The database schema 500 can be generically designed to uniformly organize disparate data from various data sources.

In this example, database schema 500 can include data tables: continuing education units (CEU) 505, license 510, regulatory agency 515, person 520, institution 525, permit 530, phone 535, location 540, census information 545, and sub-location 550. Each data table 505-550 can include one or more data fields 507-552 and have one or more relationships 560-586 to other data tables 505-550.

The CEU table 505 can include data fields 507 defining data elements such as CEU number, CEU type, a synthetic license number, a synthetic person ID, CEU date, and the like. The CEU table 505 can have a many-to-one relationship 560 to the license table 510 (i.e., many CEU records can be related to one license record).

The license table 510 can include data fields 512 defining data elements such as a synthetic license number, license ID, a synthetic person ID, license number, license type, date the license was issued, date the license will expire, and the like. The license table 510 can have a many-to-one relationship 562 to the regulatory agency table 515 (i.e., many license records can be related to one regulatory agency record).

The regulatory agency table 515 can include data fields 517 defining data elements such as a synthetic regulatory agency number, regulatory agency ID, regulatory agency name, and the like. The regulatory agency table 515 can have a one-to-many relationship 568 to the permit table 530 (i.e., one regulatory agency record can be related to many permit records).

The person table 520 can include data fields 522 defining data elements such as a synthetic person ID, gender, date of birth, social security number, and the like. The person table 520 can have a many-to-many relationship 570 to the institution table 525 (i.e., many person records can be related to many institution records) and a one-to-many relationship 564, 566, 574, and 576 to the CEU 505, license 510, phone 535, and location 540 tables.

The institution table 525 can include data fields 527 defining data elements such as a synthetic institution ID, institution name, and institution type, and the like. The institution table 525 can have a many-to-many relationship 570 to the person table 520 (i.e., many institution records can be related to many person records) and a one-to-many relationship 572 and 578 to the permit 530 and location 540 tables.

The permit table 530 can include data fields 532 defining data elements such as a synthetic permit ID, permit ID, permit number, permit type, date the permit was issued, date the permit will expire, and the like. The permit table 530 can have a one-to-one relationship 580 to the location table 540 (i.e., one permit record can be related to one location record).

The phone table 535 can include data fields 537 defining data elements such as a synthetic phone ID, phone area code, phone number, phone type, and the like. The location table 540 can include data fields 542 defining data elements such as a synthetic location ID, location street, location number, location city, location zip code, location geocode, location census TIGER/Line ID, and the like. The location table 540 can have a many-to-one relationship 582 to the phone table 535 (i.e., many location records can be related to one phone record), a one-to-one relationship 584 to the census information table 545 (i.e., one location record can be related to one census record), and an optional one-to-many relationship 586 to the sub-location table 550 (i.e., one location record can optionally be related to many sub-location records).

Data fields 507-552 identified as “synthetic” can represent identifiers that are internal to the database and can be used as relational fields between data tables 505-550 (i.e., primary or foreign keys). That is, synthetic data fields can be automatically produced by the inconsistencies system and can have no obvious relation to the actual entity being represented. For example, the person 520 named “Bob Richards” can have a synthetic person ID of “226121”.

The data table structure of database schema 500 can allow for the analysis of the data along the following dimensions: person, institution, permit, location, and phone. Each dimension can provide a unique perspective of the geocoded contractual rights data warehouse.

For example, the person dimension can aggregate data about a specific person based on their related licensing information. This can be of import as licenses are occupation-specific and unlikely to change over time.

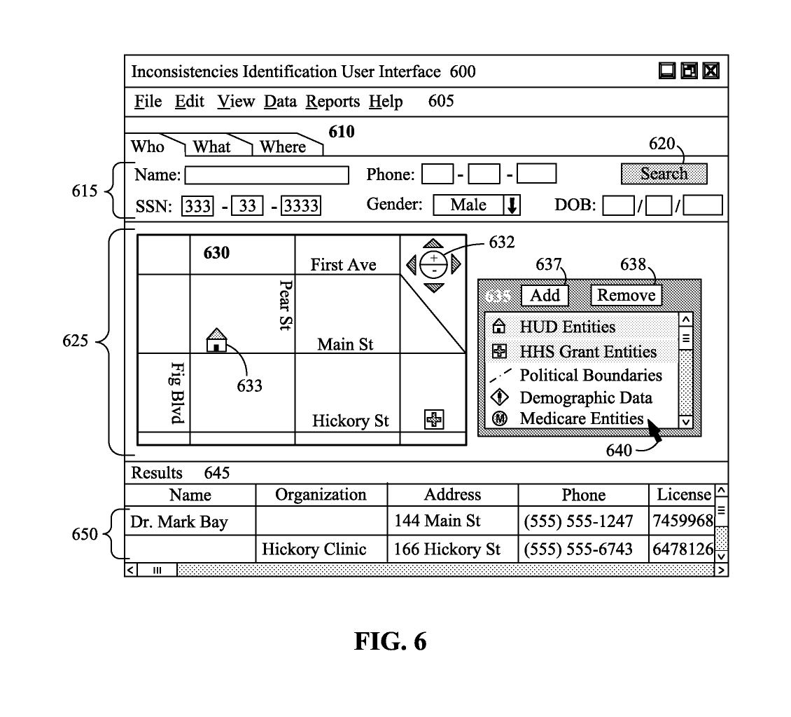

FIG. 6 is an illustration of an example inconsistencies identification user interface 600 in accordance with embodiments of the inventive arrangements disclosed herein. The example inconsistencies identification user interface 600 can be utilized within the context of system 100 and/or in conjunction with process flow 200, methods 300, method 400, and/or database schema 500.

It is important to note that the example inconsistencies identification user interface 600 shown in FIG. 6 is for illustrative purposes only, and is not intended to present an exhaustive embodiment of or limitation to the present invention.

In this example, the user can utilize the inconsistencies identification user interface 600 to perform a post-issuance assessment of a contractual right. It should be noted that a search capability can be just one of many functions provided to the user via the inconsistencies identification user interface 600.

The user can access the functionality of the inconsistencies identification user interface 600 using the menus of the toolbar 605. Selection of the search functionality from the appropriate menu of the toolbar 605 can present the user with a search definition area 610.

The search definition area 610 can contain a variety of search parameters 615 that the user can enter values for which to conduct the search. As shown in this example, the search definition area 610 can consist of multiple tabs (Who, What, Where) that reflect the primary data dimensions of the inconsistencies system. That is, a user may have information about a person and want to know what they are doing and where; or may have information about an activity and want to know who is doing it and where; or may have information about a place and want to know who is doing what there.

Each tab shown in the search definition area 610 can have a tailored set of search parameters 615. In this example, the user is searching on males having a social security number (SSN) of “333-33-3333”. Once the user is finished entering values for search parameters 615, the search button 620 can be selected to execute the search function.

Presentation of the search results can be twofold using an interactive geospatial display 625 and a data display 645. The data display 645 can present the user with the records 650 retrieved from the geocoded contractual rights data warehouse that match the entered search parameters 615. The data fields of the records 650 presented in the data display 645 can be limited include the data fields of high import (i.e., exclude primary and foreign key fields).

The interactive geospatial display 625 can present the user with a geospatial visualization for the records 650 of the data display 645. The interactive geospatial display 625 can include a map display 630 and a data layer control 635. The map display 630 can render a map of the area that corresponds to the records 650 of the search results. In the case where the locations associated with the records 650 of the search results are geographically separated, the map display 630 can be configured to present the map that corresponds to the first or primary record 650.

The type and/or level of detail of the map presented in the map display 630 can vary based upon conditions such as available map data, data source, user preferences, and/or implementation of the inconsistencies identification user interface 600.

The map display 630 can include map controls 632 and overlay icons 633. The map controls 632 can represent the control functions commonly associated with map viewing. As shown in this example, the map controls 632 can use selectable arrows to change the displayed area of the map as well as zoom in (+) and zoom out (−) magnification buttons.

The overlay icons 633 can provide graphical points of interests related to the search result records 650 and/or user-selected data layers. The overlay icons 633 can be rendered on top of the presented map of the area and can correspond to data layers available for presentation within the data layer control 635.

As discussed in previous Figures, the inconsistencies system can aggregate a large amount of disparate information having intersecting data fields. Thus, a specific entity (person or business) can have records in multiple, unrelated databases of contractual rights data.

For example, a doctor can have a record entry for their medical licenses in state board database, record entries in the HHS database for medical provider grants, record entries in the MEDICARE and/or MEDICAID databases, and so on. Further, the geographic areas involved can have additional associated information like demographics and zoning.

All these different groupings of related data can be logically categorized as data layers. The data layer control 635 can represent the mechanism by which the user can select data layers to be presented upon or removed from the map display 630. Using the associated interaction mechanism 640 (e.g., mouse, trackball, etc.), the user can select a data layer and then an appropriate action button 637 or 638.

For a data layer not currently presented in the map display 630, the user can choose the add button 637 to dynamically include the data associated with the selected data layer to the map display 630. Depending upon the data layer, this user action can render additional overlay icons 633, other graphics, or text within the map display 630.

User-selection of the remove button 638 for a selected data layer already rendered in the map display 630 can result in the removal of data elements associated with that data layer from the map display 630.

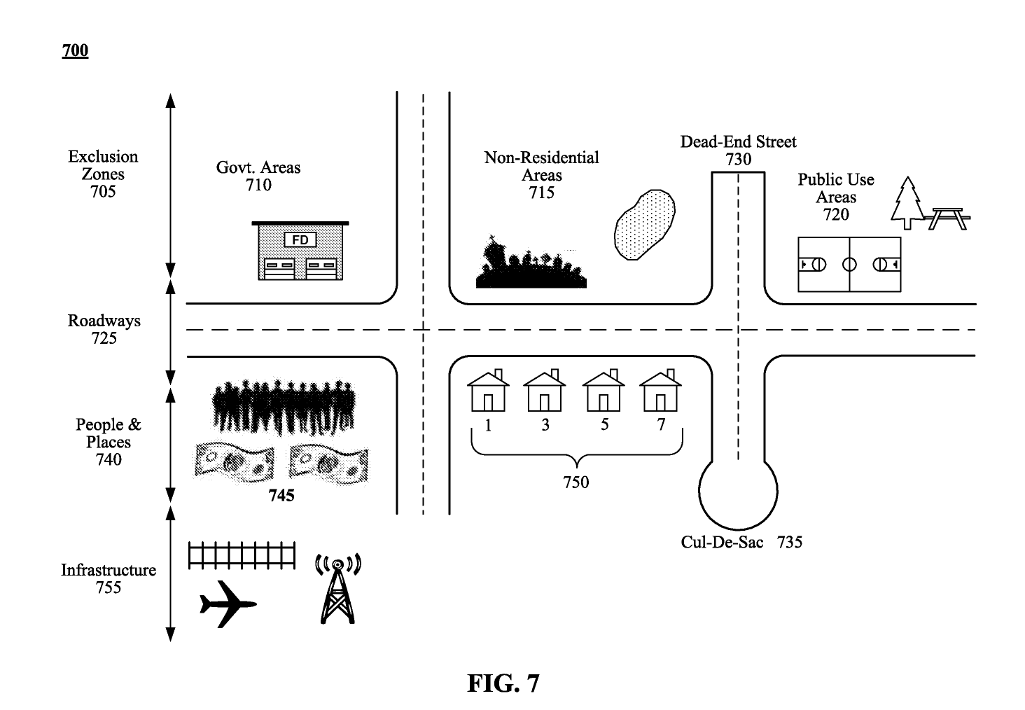

FIG. 7 is a diagram 700 illustrating the contextual data realized for mailing addresses by the contractual rights inconsistencies identification system in accordance with embodiments of the inventive arrangements disclosed herein. When processing a mailing address, the inconsistencies system can identify and/or synthesize a variety of information regarding that mailing address using the geocoded contractual rights data warehouse and geospatial data, as shown in diagram 700.

The information realized by the inconsistencies system can include exclusion zones 705, roadways 725, people and places 740, and infrastructure 755. An exclusion zone 705 can represent a geographical area where certain businesses and/or activities are not allowed or restricted.

As shown in this example, exclusion zones 705 can include government areas 710, non-residential areas 715, and public use areas 720. Government areas 710 can represent locations and/or buildings controlled or maintained by the local, State, or Federal government (e.g., hospitals, prisons, police stations, etc.). In government areas 710, economic activities can have greater restriction, depending on local and/or State laws.

For example, a request for a daycare providers license with an address corresponding to the local prison can be deemed as more suspect than an address that corresponds to a private home.

A non-residential area 715 can represent a location that is not zoned and/or usable for residential purposes, such as cemeteries, landfills, and quarries. While many non-residential areas 715 can contain valid mailing addresses for businesses, these addresses would be unsuitable for activities like healthcare billing. Similarly, public use areas 720 (e.g., parks, public libraries, public schools, etc.) cannot be used for certain activities as well as businesses.

Roadway 725 data can allow the inconsistencies system to provide additional context. For example, an address cannot be valid if the building number extends past the end of a dead-end street 730. Further, a request for a liquor license corresponding to an address that is on a cul-de-sac 735 can be processed as having a higher degree of geospatial incompatibility than a request for a daycare provider license.

The people and places 750 data can represent a variety of census information 745 as well as the geocoded addresses 750 not associated with an exclusion zone 705 or infrastructure 765 (i.e., residences). As previously discussed, the census information 745 can provide the demographic data for people involved in the contractual rights request. That is, the census information 745 can indicate who lives where.

Geocoded addresses 750 can allow the inconsistencies system to recognize the same location when written in multiple, valid formats. For example, the mailing address for House 3 may be able to be validly written as “123 Magnolia Blvd” and “123 SR144 (State Route 144)”. By using geocoded addresses 750, the inconsistencies system can detect that a new request using the Magnolia Blvd. address is a duplicate of an existing application that uses the SR144 address.

Lastly, infrastructure 765 elements like railroads and ports can provide additional information that can be utilized in inconsistency rulesets and processing by the inconsistencies system. For example, a person applying for a mariner's license in an area without a port authority or in a land-locked area can be seen as more suspect than in a coastal area.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for detecting geospatial inconsistencies for contractual rights comprising:
identifying an application document, a renewal application, or a list of current right grantees for a contractual right, wherein said contractual right defines a compensatory relationship between two entities for specified conditions;
determining at least one address from the document, wherein activities related to the contractual right are to be performed;
converting the address into a set of geospatial coordinates;
querying a database of geospatially recorded items for activities proximate to the converted set of geospatial coordinates;
generating a geospatial inconsistency score based on the results from the database and their level of incompatibility with conducting an activity for which the contractual right relates;
when the geospatial inconsistency score is less than or equal to a previously established threshold, indicating that no problem has been detected that indicates that the contractual right is improper; and
when the geospatial inconsistency score exceeds the previously established threshold, indicating that a problem has been detected that warrants further analysis of the contractual right.

2. The method of claim 1, wherein the contractual right is at least one of a government right permitting an entity to perform a regulated activity or provides the entity with a grant of money from a government source and an insurance policy agreement.

3. The method of claim 1, wherein the database of the geospatially recorded items is a database synthesized from a plurality of data sources that have a geospatial link, wherein, when synthesizing the information from the plurality of data sources, absolute geospatial coordinates are determined for addresses contained within the plurality of data sources, said absolute geospatial coordinates being used in the database of the geospatially recorded items.

4. The method of claim 1, further comprising:
including in the database of geospatially recorded items regions of land reserved for specific uses in which activities related to the contractual right are not able to be performed, said regions of land including school regions, cemetery regions, hospital regions, universities, and parks; and
when the geospatial coordinate of the address from the application falls within one of the regions of land, increasing the geospatial inconsistency score so that it exceeds the previously established threshold.

5. The method of claim 1, further comprising:
including in the database of geospatially recorded items businesses serving alcohol to customers, pawn shops, check-cashing stores, and strip clubs;
determining that the activities related to the contractual right are unlikely to be located proximate to any of the following unlikely-proximate-businesses: businesses serving alcohol to customers, pawn shops, check-cashing stores, and strip clubs; and
each time the geospatial coordinate of the address is within a predefined range of one of the unlikely-proximate-businesses, increasing the geospatial inconsistency score.

6. The method of claim 1, further comprising:
including in the database of geospatially related items hotels, temporary stay accommodations, and post-office boxes locations;
determining that the activities related to the contractual right are unlikely to be located proximate to any of the following non-permanent addresses: hotels, temporary stay accommodations, and post-office boxes locations; and
each time the geospatial coordinate of the address is within a predefined range of one of the non-permanent addresses, increasing the geospatial inconsistency score.

7. A method of claim 1, further comprising:
generating the geospatial inconsistency score responsive to an application for the contractual right and before the contractual right is granted.

8. A method of claim 1, further comprising:
generating the geospatial inconsistency score responsive to an inquiry into an already granted contractual right, wherein said inquiry is designed to indicate whether the granted contractual right is improper and should therefore be revoked.

9. The method of claim 1, further comprising:
generating the geospatial inconsistency score responsive to a renewal application for renewing an existing contractual right, wherein said contractual right is not renewed if the geospatial inconsistency score indicates that the contractual right is improper.

10. The method of claim 1, further comprising:
generating a report showing the calculation of the geospatial inconsistency score, said report comprising the geospatial entities from the database that cause the geospatial inconsistency score to be raised and an amount that each raised the geospatial inconsistency score.

11. The method of claim 1, wherein each of the steps of claim 1 are performed by a processor of a computing device executing instructions of a computer program product, said computer program product being digitally encoded in a physical storage medium.

12. A system for identifying inconsistencies contained in contractual rights requests comprising:
a plurality of contractual rights data obtained from a plurality data sources;
a contractual right message for a contractual right submitted by an entity, wherein said contractual right message comprises a plurality of data provided by said entity;
a plurality of inconsistency rulesets defining conditions indicative of misrepresentation by the submitting entity, wherein said conditions are expressed in terms of the data contained in the contractual rights message; and
a contractual rights inconsistencies identification data system configured to generate an inconsistency report for the contractual rights message, wherein said inconsistency report expresses a likelihood of misrepresentation by the entity based upon the data of the contractual rights message, the plurality of inconsistency rulesets, and a geocoded contractual rights data warehouse, wherein said geocoded contractual rights data warehouse is synthesized from the plurality of contractual rights data.

13. A method for identifying inconsistencies contained in contractual rights requests comprising:
synthesizing a data warehouse of contractual rights from a plurality of data sources by a contractual rights inconsistencies identification data system, wherein each record of the data warehouse having at least one address of a physical location contains geospatial information regarding said at least one address;
in response to receipt of a message relating to a contractual right, analyzing contents of the message with respect to the data warehouse;
calculating a geospatial inconsistency score for the message using results of the analysis, wherein said geospatial inconsistency score represents a likelihood of contractual right being for fraudulent activities;
comparing the calculated geospatial inconsistency score with a predetermined inconsistency threshold value;
generating an inconsistency report for the message comprising results of at least one of the analysis and the geospatial inconsistency score comparison; and
conveying said inconsistency report to a designated agent.

14. The method of claim 13, wherein synthesizing the data warehouse further comprises:
acquiring source data files from the plurality of data sources;
determining at least one element of metadata for each source data file;
for each record contained in the source data files, normalizing values of specified data fields in accordance with a predetermined format;
creating a new record within the data warehouse for a source data record;
populating data fields of said new record with data values of corresponding fields in the source data record;
when the source data record contains at least one address, geocoding the at least one address within the new data warehouse record; and
storing said new record in the data warehouse.

15. The method of claim 14, wherein geocoding the at least one address further comprises:
determining geospatial coordinates for the at least one address from a set of geospatial data, wherein said geospatial coordinates uniquely identify the physical location in terms of latitudinal and longitudinal positioning; and
adding said geospatial coordinates to the new data warehouse record.

16. The method of claim 15, further comprising:
determining a geospatial entity object code (geocode) for the at least one address, wherein said geocode is obtained using a geocoding software application; and
adding said geocode to the new data warehouse record.

17. The method of claim 16, wherein the geocode is a GEOHASH value.

18. The method of claim 14, wherein the synthesizing data warehouse is a third normal form RDBMS (relational database management system).

19. The method of claim 14, further comprising:
determining a topographically integrated geographic encoding and references (TIGER) SHAPEFILE associated with the at least one address;
obtaining a plurality of U.S. Census data associated with the determined TIGER SHAPEFILE; and
adding said plurality of U.S. Census data to the new data warehouse record.

20. The method of claim 13, wherein the calculating of the geospatial inconsistency score further comprises:
identifying at least one inconsistency ruleset applicable to the new contractual rights request, wherein an inconsistency ruleset comprises a plurality of rules defining conditions indicative of a misrepresentation on a part of an entity submitting the contractual rights message;
applying said at least one inconsistency ruleset to the new contractual rights message, wherein satisfaction of a rule contained in an inconsistency ruleset indicates an infraction; and
synthesizing infractions identified by the application of the at least one inconsistency ruleset into the geospatial inconsistency score.

21. The method of claim 13, wherein the analysis of the new contractual rights message further comprises:
mining the data warehouse creating a subset of records related to data values contained in the new contractual rights message; and
utilizing said subset of data warehouse records in lieu of the data warehouse in its entirety when calculating the geospatial inconsistency score and generating the inconsistency report for the new contractual rights message.

22. The method of claim 13, wherein each of the steps of claim 11 are performed by a processor of a computing device executing instructions of a computer program product, said computer program product being digitally encoded in a physical storage medium.
